(19) United States
(12) Patent Application Publication
(10) Pub. No.: US 2016/0291289 A1
(43) Pub. Date: Oct. 6, 2016

(54) OPTICAL ELEMENT, OPTICAL SYSTEM INCLUDING THE SAME, AND MANUFACTURING METHOD

(71) Applicant: CANON KABUSHIKI KAISHA, Tokyo (JP)

(72) Inventors: Tomohiko Ishibashi, Utsunomiya-shi (JP); Hironobu Koga, Utsunomiya-shi (JP)

(21) Appl. No.: 15/070,873

(22) Filed: Mar. 15, 2016

(30) Foreign Application Priority Data
Mar. 31, 2015 (JP) 2015-074504

(51) Int. Cl. G02B 13/00; G02B 27/00; G02B 1/04

(52) U.S. Cl. CPC G02B 13/006; G02B 1/041; G02B 27/0025

(57) ABSTRACT

An optical element includes a first optical component, a second optical component cemented to the first optical component, and a third optical component cemented to the second optical component. At least either one of the first and third optical components and the second optical component are cemented to each other via a cement member. Following conditional expressions are satisfied:

−0.5<Log(E1×E3/E2²)<10,

and

−0.2<Log(E2/Ec)<10,
where Young's moduli of the first to third optical components and the cement member are respectively denoted by E1, E2, E3, and Ec.

### BACKGROUND OF THE INVENTION

1. Field of the Invention

The present invention relates an optical element in which a plurality of optical components is cemented, and an optical system including the same.

2. Description of the Related Art

In recent years, a compact and lightweight optical system having high optical performance has been demanded as an optical system (imaging optical system) used in an optical apparatus such as a camera and a video camera. Japanese Patent Application Laid-Open No. 2010-117472 describes an optical system that can effectively correct chromatic aberration while achieving miniaturization, by employing an optical element in which an optical component formed of inorganic glass and an optical component formed of resin are cemented.

In the optical element described in Japanese Patent Application Laid-Open No. 2010-117472, however, coefficients of linear expansion of inorganic glass and resin greatly differ from each other. Thus, if an environmental temperature changes, the respective shapes of the optical components change, so that excellent optical performance may fail to be obtained.

### SUMMARY OF THE INVENTION

An object of the present invention is to provide an optical element including a plurality of cemented optical components, and being excellent in environment resistance, and an optical system and an optical apparatus including the same.

To achieve the above object, an optical element according to an aspect of the present invention includes a first optical component, a second optical component cemented to the first optical component, and a third optical component cemented to the second optical component. At least either one of the first and third optical components and the second optical component are cemented to each other via a cement member. Following conditional expressions are satisfied:

−0.5<Log(E1×E3/E2²)<10,

and

−0.2<Log(E2/Ec)<10,

where Young's moduli of the first to third optical components and the cement member are respectively denoted by E1, E2, E3, and Ec.

Further features of the present invention will become apparent from the following description of exemplary embodiments (with reference to the attached drawings).

### BRIEF DESCRIPTION OF THE DRAWINGS

FIG. 1 is a main part sectional view of an optical element according to Example 1 of the present invention.

FIGS. 2A and 2B are diagrams illustrating deformation amounts of optical surfaces according to Example 1 and Comparative Example.

FIG. 3 is a sectional view of an optical system according to Example 2 of the present invention in an in-focus state in which the optical system focuses on an infinite object.

FIG. 4 is an aberration diagram of the optical system according to Example 2 of the present invention in an in-focus state in which the optical system focuses on an infinite object.

FIG. 5 is a main part sectional view of an optical element according to Example 3 of the present invention.

FIG. 6 is a sectional view of an optical system according to Example 4 of the present invention in an in-focus state in which the optical system focuses on an infinite object.

FIG. 7 is an aberration diagram of the optical system according to Example 4 of the present invention in an in-focus state in which the optical system focuses on an infinite object.

FIG. 8 is a main part sectional view of an optical element according to Example 5 of the present invention.

FIG. 9 is a sectional view of an optical system according to Example 6 of the present invention in an in-focus state in which the optical system focuses on an infinite object.

FIGS. 10A to 10C are aberration diagrams of the optical system according to Example 6 of the present invention in an in-focus state in which the optical system focuses on an infinite object.

FIG. 11 is a main part sectional view of an optical element according to Example 7 of the present invention.

FIG. 12 is a perspective view of an optical apparatus according to an exemplary embodiment of the present invention.

### DESCRIPTION OF THE EMBODIMENTS

A preferred exemplary embodiment of the present invention will be described below with reference to the drawings. In addition, each drawing may be drawn in a scale different from an actual scale for the sake of convenience. In addition, in the drawings, the same members are assigned the same reference numeral, and the redundant descriptions will be omitted.

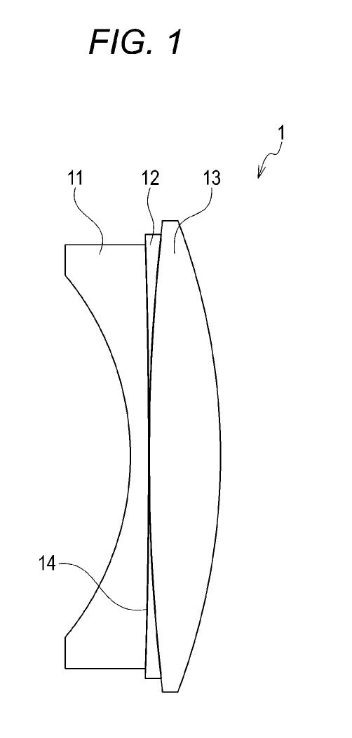

FIG. 1 is a main part schematic view (main part sectional view) of an optical element 1 according to the present exemplary embodiment in a cross section including an optical axis. The optical element 1 according to the present exemplary embodiment includes three cemented (integrated) optical components. Specifically, the optical element 1 includes a first optical component 11, a second optical component 12 cemented to the first optical component 11, and a third optical component 13 cemented to the second optical component 12. At least either one of the first and third optical components and the second optical component 12 are cemented to each other via a cement member 14.

In addition, the optical element 1 satisfies the following Conditional Expressions (1) and (2):

−0.5<Log(E1×E3/E2²)<10 (1)

and

−0.2<Log(E2/Ec)<10 (2),

where Young's moduli of the first to third optical components and the cement member 14 are respectively denoted by E1, E2, E3, and Ec.

With the above configuration, the optical element 1 according to the present exemplary embodiment achieves excellent environment resistance. The optical element 1 will be described in detail below.

An optical component in the present exemplary embodiment refers to an optical member formed of inorganic material such as glass, organic material such as plastic (resin), or the like, and having a refractive function. In addition, an optical component according to the present exemplary embodiment does not include components that do not substantially have refractive power. For example, a cement member (adhesive, etc.) for cementing optical components, and a thin film and coating material for anti-reflection and higher adhesiveness are not included in the an optical component according to the present exemplary embodiment. The optical element 1 illustrated in FIG. 1 employs a configuration including three optical components. The number of optical components, however, is not limited to three as long as the configuration includes three or more cemented optical components including the first to third optical components.

The second optical component 12 according to the present exemplary embodiment is formed of organic material. Here, organic material in the present exemplary embodiment includes material obtained by curing resin material, and material obtained by dispersing inorganic particulates in organic material and curing the resultant compound (organic compound). For example, acrylic, polycarbonate, polyvinyl carbazole, a mixture of these, or a mixture of these and another organic material or inorganic material can be employed as organic material. In addition, the second optical component 12 may be composed of a plurality of optical members being formed of organic materials different from one another.

The optical element 1 can be manufactured by a step of forming the first optical component 11 and the third optical component 13, a step of forming the second optical component 12 on an optical surface of the third optical component 13, and a step of cementing optical surfaces of the first optical component 11 and the second optical component 12. In this procedure, the first optical component 11 and the second optical component 12 are cemented to each other via the cement member 14.

The manufacturing method of the optical element 1 is not limited to this. The second optical component 12 and the third optical component 13 may be cemented to each other by the cement member 14 after the second optical component 12 is formed on the optical surface of the first optical component 11. Alternatively, a method of cementing the second optical component 12 to each of the first optical component 11 and the third optical component 13 by the cement member 14 after forming the second optical component 12 in advance may be employed.

In addition, an “optical surface” in the present exemplary embodiment refers to a portion having a continuous curved surface (a spherical surface with a constant curvature radius or an aspherical surface defined by the same definitional expression) in each optical component. In addition, in the present exemplary embodiment, optical surfaces of optical components are all mirror surfaces. In other words, surfaces being not mirror surfaces that are for supporting optical components, end surfaces in a direction orthogonal to an optical axis (radial direction) in a cross section including the optical axis, and the like are non-optical surfaces not included in the optical surfaces.

A “diameter of an optical component” in the present exemplary embodiment refers to a distance (width) between end portions of each optical component or the positions of these end portions, in a radial direction in a cross section including an optical axis. In addition, the maximum diameter of an optical component including non-optical surfaces will be referred to as an external diameter, and the maximum diameter of an optical surface will be referred to as an inner diameter. In addition, a “cemented surface” in the present exemplary embodiment refers to a surface of each optical component where a corresponding optical component is cemented to another optical component regardless of the presence or absence of a cement member.

In the optical element 1 according to the present exemplary embodiment, by appropriately setting the shape and material of each optical component, miniaturization and excellent optical performance can be achieved. Nevertheless, organic material is generally prone to deform due to environmental variations as compared with inorganic material such as glass. For example, under the high-temperature environment or low-temperature environment in which the temperature of atmosphere (air, etc.) has changed with respect to room temperature, an optical component formed of organic material expands or constricts, so that the optical characteristics such as a refractive index of the optical component change. In addition, under high-humidity environment, the surface shape of an optical component formed of organic material deforms due to water absorption, so that the optical characteristics of the optical component change.

In this case, a conceivable method includes a method for reducing the influence of environmental variation by thinning the thickness of the optical component formed of organic material to reduce an area of the surface exposed to atmosphere. This, however, generates other concerns. For example, since organic material has lower mechanical strength as compared with inorganic glass and the like, if the optical component formed of organic material is formed to be thin, the optical component may deform when being supported by a lens barrel or the like.

Thus, the optical element 1 according to the present exemplary embodiment employs a configuration in which both of the two optical surfaces (entrance surface and exit surface) of the second optical component 12 formed of organic material are cemented to the optical surfaces of other optical components. With this configuration, the optical surfaces of the second optical component 12 can be prevented from being exposed to atmosphere, so that the deformation caused by environmental variations can be suppressed. Furthermore, the mechanical strength of the second optical component 12 can be maintained.

Nevertheless, since coefficients of linear expansion of inorganic glass and organic material greatly differ from each other, under the high/low-temperature environment, the second optical component 12 and other optical components non-uniformly expand and constrict. As a result, the shape of each optical component may change, and excellent optical performance (imaging performance) may fail to be obtained. In this case, the degree of shape change of each optical component that is caused by the temperature change is correlated to mechanical characteristics of a cement member that cements optical components, and in particular, correlated to a Young's modulus.

Thus, the optical element 1 according to the present exemplary embodiment suitably selects Young's moduli of each optical component and the cement member 14 by satisfying the above-described Conditional Expressions (1) and (2). The environment resistance can be thereby enhanced.

Specifically, in the optical element 1, the Young's modulus of the cement member 14 is set to be smaller than the Young's modulus of the second optical component 12, so that the distortion of the second optical component 12 that is caused by a temperature change can be absorbed by the shape change of the cement member 14. This can reduce the shape changes of the optical surfaces of the first and third optical components that are not cemented to the second optical component, so that changes in optical characteristics can be suppressed. In addition, since the second optical component 12 and the cement member 14 are not exposed to atmosphere, their shape changes exert small influence on the optical performance.

When the value of the optical element 1 exceeds the upper limit of Conditional Expression (1), the rigidity of the second optical component 12 becomes too small as compared with the rigidities of the first and third optical components, so that the shape of the second optical component 12 excessively deforms in response to a temperature change. As a result, an effect of reducing the shape change of the optical element 1 that is achieved by the cement member 14 cannot be sufficiently obtained. In addition, when the value of the optical element 1 falls below the lower limit of Conditional Expression (1), the rigidity of the second optical component 12 becomes sufficiently large as compared with the rigidities of the first and third optical components, so that the optical surface shapes of the first and third optical components are prevented from deforming to such an extent as to influence the optical performances, irrespective of the mechanical characteristics of the cement member 14. When the value of the optical element 1 falls below the lower limit of Conditional Expression (2), the rigidity of the cement member 14 becomes too large, so that an effect of mitigating the shape change of the second optical component that is caused by a temperature change cannot be obtained. As a result, an effect of reducing the shape changes of the optical surfaces of the first and third optical components that are not cemented to the second optical component cannot be sufficiently obtained. In addition, when the value of the optical element 1 exceeds the upper limit of Conditional Expression (2), the rigidity of the cement member 14 becomes too small. As a result, for example, each optical component may deform due to its own weight, each cemented surface may peel off, or the cement member 14 may split up.

Furthermore, it is preferable to sequentially satisfy the following Conditional Expressions (1a), (2a) to (1d), and (2d):

0<Log(E1×E3/E2²)<9 (1a),

0<Log(E2/Ec)<9 (2a),

0.5<Log(E1×E3/E2²)<8 (1b),

0.2<Log(E2/Ec)<8 (2b),

1<Log(E1×E3/E2²)<7 (1c),

0.4<Log(E2/Ec)<7 (2c),

1.5<Log(E1×E3/E2²)<6 (1d),

and

0.6<Log(E2/Ec)<6 (2d).

In this case, the optical element 1 according to the present exemplary embodiment desirably satisfies either one of the following Conditional Expressions (3) and (4):

0<t2e/t2c<0.95 (3),

and

1.05<t2e/t2c<10000 (4),

where the thicknesses in an optical axis direction on the optical axis and at the maximum diameter of the second optical component are respectively denoted by t2c and t2e.

Under the high-temperature environment or the low-temperature environment, as the amount of change in the radial direction of the thickness in the optical axis direction of the second optical component 12 becomes larger, non-uniform expansion and constriction of the second optical component 12 become more prominent, so that the shape change of each optical surface easily occurs. Thus, when the second optical component 12 has positive refractive power, the optical element 1 desirably satisfies Conditional Expression (3), and when the second optical component 12 has negative refractive power, the optical element 1 desirably satisfies Conditional Expression (4). As a result, the effect of reducing the shape change that is achieved by satisfying Conditional Expressions (1) and (2) becomes larger.

Furthermore, it is preferable to sequentially satisfy the following Conditional Expression(s) (3a), (4a) to (3d), or (4d):

0.0005<t2e/t2c<0.90 (3a),

1.5<t2e/t2c<2000 (4a),

0.001<t2e/t2c<0.70 (3b),

2<t2e/t2c<1000 (4b),

0.002<t2e/t2c<0.50 (3c),

4<t2e/t2c<600 (4c),

and

0.004<t2e/t2c<0.30 (3d),

or

6<tre/t2c<200 (4d).

In addition, the optical element 1 according to the present exemplary embodiment desirably satisfies the following Conditional Expression (5):

0<Log(E2/Ec)/Log(t2/tc)<20 (5),

where the maximum thicknesses in the optical axis direction of the second optical component 12 and the cement member 14 are respectively denoted by t2 and tc.

By appropriately setting the shape of the cement member 14, i.e., the thickness in the optical axis direction of the cement member 14 so as to satisfy Conditional Expression (5), the shape change of the second optical component 12 that is caused by a temperature change can be absorbed by the shape change of the cement member 14. When the value of the optical element 1 falls below the lower limit of Conditional Expression (5), the shape change of the cement member 14 becomes too small, so that an effect of reducing the shape changes of the optical surfaces of the first and third optical components that are not cemented to the second optical component cannot be sufficiently obtained. In addition, when the value of the optical element 1 exceeds the upper limit of Conditional Expression (5), the shape change of the cement member 14 becomes too large. As a result, for example, each optical component may deform due to its own weight, each cemented surface may peel off, or the cement member 14 may split up.

Furthermore, it is preferable to sequentially satisfy the following Conditional Expressions (5a) to (5d):

0.1<Log(E2/Ec)/Log(t2/tc)<15 (5a),

0.2<Log(E2/Ec)/Log(t2/tc)<10 (5b),

0.4<Log(E2/Ec)/Log(t2/tc)<8 (5c),

and

0.5<Log(E2/Ec)/Log(t2/tc)<5 (5d).

In each optical component and the cement member 14, the shape change in each optical axis direction that is caused by a temperature change is proportional to the thickness in a corresponding optical axis direction. Thus, the product of the thickness in an optical axis direction and the Young's modulus is correlated to stress generated in each optical component or the cement member 14. When the stress generated in the cement member 14 is sufficiently smaller than the stress generated in the second optical component 12, the shape change of each optical component can be reduced by changing the shape of the cement member 14. Thus, for further enhancing the environment resistance, the optical element 1 according to the present exemplary embodiment desirably satisfies the following Conditional Expression (6):

−20<Log(tc×Ec/(t2×E2))<0 (6).

When the value of the optical element 1 falls below the lower limit of Conditional Expression (6), the shape change of the cement member 14 becomes too large. As a result, for example, each optical component may deform due to its own weight, each cemented surface may peel off, or the cement member 14 may split up. When the value of the optical element 1 exceeds the upper limit of Conditional Expression (6), the shape change of the cement member 14 becomes too small, so that an effect of reducing the shape changes of the optical surfaces of the first and third optical components that are not cemented to the second optical component cannot be sufficiently obtained.

Furthermore, it is preferable to sequentially satisfy the following Conditional Expressions (6a) to (6d):

−16<Log(tc×Ec/(t2×E2))<−0.2 (6a),

−12<Log(tc×Ec/(t2×E2))<−0.5 (6b),

−10<Log(tc×Ec/(t2×E2))<−1 (6c),

and

−8<Log(tc×Ec/(t2×E2))<−1.5 (6d).

When the thickness in the optical axis direction of the cement member 14 changes in the radial direction, that is, when the cement member 14 has a shape with refractive power, the effect of reducing the shape change of an optical surface cannot be sufficiently obtained. Thus, it is desirable to satisfy the following Conditional Expression (7):

0≦|φc/φ2|<0.2 (7),

where refractive powers of the second optical component 12 and the cement member 14 are respectively denoted by φ2 and φc.

When the value of the optical element 1 falls outside the range of Conditional Expression (7), the refractive power of the cement member 14 becomes relatively larger than the refractive power of the second optical component 12, so that an effect of reducing the shape changes of the optical surfaces of the first and third optical components that are not cemented to the second optical component cannot be sufficiently obtained.

Furthermore, it is preferable to sequentially satisfy the following Conditional Expressions (7a) to (7c):

0≦|φc/φ2|<0.1 (7a),

0≦|φc/φ2|<0.05 (7b),

and

0≦↑φc/φ2|<0.02 (7c).

In addition, as the ratio of the coefficient of linear expansion of the second optical component 12 to the coefficient of linear expansion of the cement member 14 is set to be smaller, the amount of expansion or constriction of each optical component that is caused by a temperature change becomes smaller. Thus, it is desirable to satisfy the following Conditional Expression (8):

−10<Log(α2/αc)/Log(t2/tc)<10 (8),

where the coefficients of linear expansion of the second optical component 12 and the cement member 14 are respectively denoted by α2 and αc.

When the value of the optical element 1 exceeds the upper limit of Conditional Expression (8), the shape change of the second optical component 12 becomes too large, so that an effect of mitigating the shape change of the second optical component 12 that is caused by a temperature change cannot be obtained. In addition, when the value of the optical element 1 falls below the lower limit of Conditional Expression (8), the shape change of the cement member 14 becomes too large. As a result, for example, each optical component may deform due to its own weight, each cemented surface may peel off, or the cement member 14 may split up.

Furthermore, it is preferable to sequentially satisfy the following Conditional Expressions (8a) to (8d):

−8<Log(α2/αc)/Log(t2/tc)<8 (8a),

−6<Log(α2/αc)/Log(t2/tc)<6 (8b),

−4<Log(α2/αc)/Log(t2/tc)<4 (8c),

and

−2<Log(α2/αc)/Log(t2/tc)<2 (8d).

In addition, it is desirable to satisfy the following Conditional Expression (9):

0≦tcc/t2c<1 (9),

where the thicknesses in the optical axis direction on the optical axis of the second optical component 12 and the cement member 14 are respectively denoted by t2c and tcc.

By satisfying Conditional Expression (9), the thickness of the cement member 14 becomes thinner than the thickness of the second optical component 12, so that an absolute amount of the shape change of the cement member 14 can be made smaller. Thus, the shape change of an optical surface that is caused by a temperature change can be sufficiently suppressed.

Furthermore, it is preferable to sequentially satisfy the following Conditional Expressions (9a) to (9c):

0≦tcc/t2c<0.85 (9a),

0≦tcc/t2c<0.5 (9b),

and

0≦tcc/t2c<0.15 (9c).

As described above, when the thickness in the optical axis direction of the cement member 14 changes in the radial direction, the effect of reducing the shape change of the optical surface cannot be sufficiently obtained. In particular, when the thickness of the cement member 14 at the maximum diameter of the cement member 14, i.e., at the maximum diameter of the cemented surface of the first optical component 11 and the second optical component 12 becomes thicker than the thickness on the optical axis of the cement member 14, the influence of a temperature change becomes larger. Thus, it is desirable to satisfy the following Conditional Expression (10):

0.8<tce/tcc<1.2 (10),

where the thickness in the optical axis direction at the maximum diameter of the cement member 14 is denoted by tce.

By satisfying Conditional Expression (10), the thicknesses on the optical axis and at the maximum diameter of the cement member 14 can be set to a level similar to each other. It therefore becomes possible to sufficiently suppress the shape change of an optical surface that is caused by a temperature change.

Furthermore, it is preferable to sequentially satisfy the following Conditional Expressions (10a) and (10b):

0.85<tce/tcc<1.15 (10a),

and

0.9<tce/tcc<1.1 (10b).

As described above, according to the optical element 1 according to the present exemplary embodiment, excellent environment resistance can be achieved. Next, examples of the optical element 1 will be described in detail.

### Example 1

An optical element 1 according to Example 1 of the present invention will be described in detail below. The configuration of the optical element 1 according to the present example is similar to the configuration according to the above-described exemplary embodiment.

In the present example, a first optical component 11 and a third optical component 13 are formed of inorganic glass, and are optical components having refractive powers different in sign from each other. The first optical component 11 is formed of the S-TIH1 of Ohara Inc., and is an optical component having a negative meniscus shape with a concave surface facing toward an object side. The third optical component 13 is formed of the S-LAL14 of Ohara Inc., and is a biconvex-shaped optical component having positive refractive power. In each of the first optical component 11 and the third optical component 13, one optical surface is exposed to atmosphere.

A second optical component 12 is formed of a compound obtained by dispersing Indium-Tin-Oxide (ITO) particulates in polymethylmethacrylate (PMMA) (acrylic resin) at a volume ratio of 15%, and is a biconcave-shaped optical component having negative refractive power. The thickness in the optical axis direction of the second optical component 12 increases from the optical axis toward the end portions. In addition, the cement member 14 is formed of the EP-001K of CEMEDINE CO., LTD., which is epoxy resin-based adhesive.

The respective Young's moduli E1, E2, and E3 of the first to third optical components are 88.4 GPa, 1.8 GPa, and 111.8 GPa, and the Young's modulus Ec of the cement member 14 is a 0.003 GPa, which satisfy the above-described Conditional Expressions (1) and (2). As a result, the shape change of the optical surface of the optical element 1 that is caused by a temperature change can be suppressed.

For describing an effect of the optical element 1 according to the present example, an optical element according to Comparative Example will now be considered. The optical element according to Comparative Example has a configuration similar to that of the optical element 1 according to the present example except that the TB3114 of ThreeBond Co., Ltd., which has a Young's modulus of 7.9 GPa, is used as a cement member.

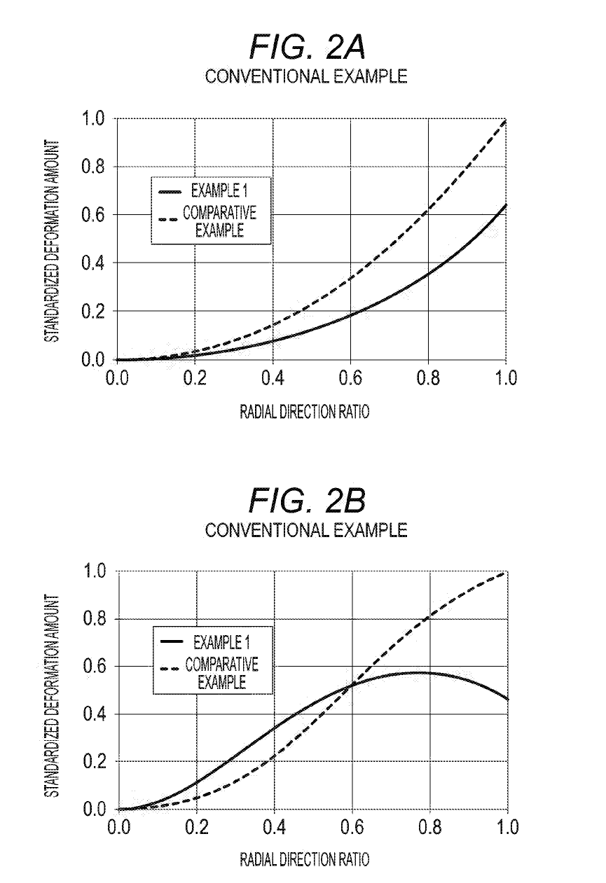

FIGS. 2A and 2B respectively illustrate the degrees of shape changes (deformation amounts) of an optical surface of the first optical component 11 that is exposed to atmosphere and an optical surface of the third optical component 13 that is exposed to atmosphere, when a temperature changes. FIGS. 2A and 2B illustrate, using a finite element method, calculation results of the amounts of deformation in the optical axis direction that is generated when a temperature changes from room temperature by +40° C. In FIGS. 2A and 2B, solid lines indicate Example 1 and broken lines indicate a conventional example. In addition, a vertical axis indicates a standardized deformation amount standardized with the maximum deformation amount of an optical surface according to Comparative Example being set to 1.0, and a horizontal axis indicates a radial direction ratio standardized with the maximum diameter of the optical surface being set to 1.0.

As clearly seen from FIG. 2A, the deformation amount of the optical surface of the first optical component 11 according to Example 1 is smaller by approximately 35% at most than that according to Comparative Example, and the deformation amount of the optical surface of the third optical component 13 according to Example 1 is smaller by approximately 43% at most than that according to Comparative Example. Based on these results, it can be seen that the optical element 1 according to the present example achieves excellent environment resistance.

### Example 2

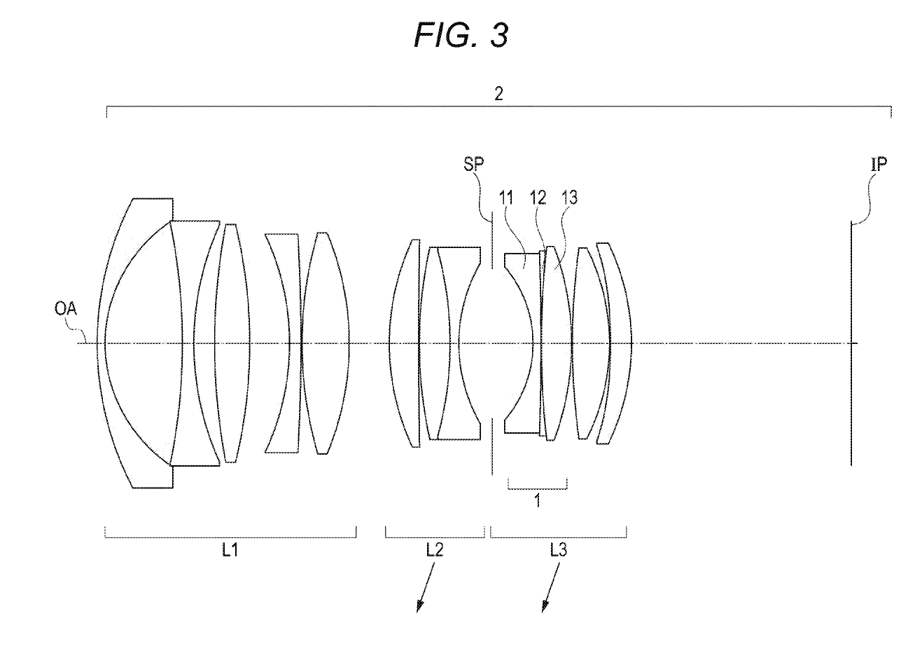

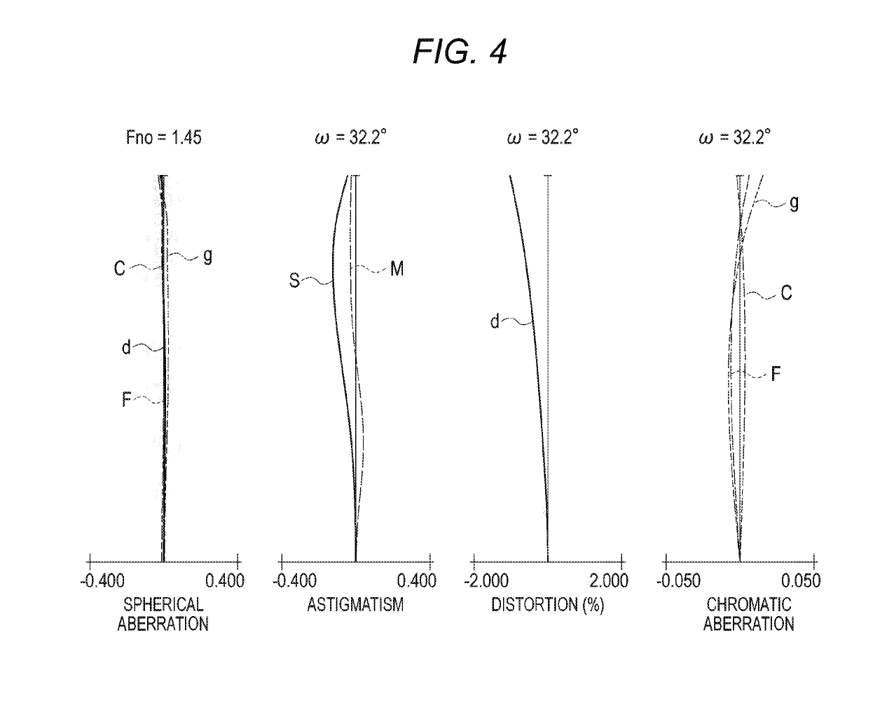

FIG. 3 is a main part sectional view of an optical system 2 according to Example 2 that includes the optical element 1 according to Example 1. In FIG. 3, IP represents an image plane, OA represents an optical axis, SP represents an aperture diaphragm, and arrows represent the loci of movement in the optical axis direction of lens units and the aperture diaphragm SP during focusing from infinity to short distance. FIG. 4 is an aberration diagram of the optical system 2 when the optical system 2 focuses on an infinite object.

The optical system 2 according to the present example consists of a first lens unit L1 having positive refractive power, a second lens unit L2 having positive refractive power, and a third lens unit L3 having positive refractive power that are arranged in order from an object side to an image side. The third lens unit L3 includes the optical element 1 according to Example 1. In the optical system 2, an interval between lens units changes during focusing.

In the optical element 1, the second optical component 12 formed of a compound of PMMA and ITO particles has anomalous partial dispersion, and a partial dispersion ratio egF related to a g-line and an F-line thereof is smaller as compared with that of general glass material. By employing the optical element 1 having such anomalous partial dispersion, the optical system 2 can effectively correct axial chromatic aberration and transverse chromatic aberration.

In addition, in the optical element 1, the maximum diameter of the third optical component 13 is larger than the maximum diameters of the second optical component 12 and the first optical component 11. Thus, in the optical system 2, the optical element 1 can be held (fixed) by a holding unit such as a lens barrel only via the third optical component 13. It therefore becomes possible to suppress the distortion of an optical surface that is caused when each optical component expands and constricts in response to a temperature change. The configuration, however, is not limited to this configuration as long as the configuration holds the optical element 1 via at least either one of the first optical component 11 and the third optical component 13.

In addition, the optical system 2 according to the present example is a coaxial system in which a center of curvature of each optical surface and the center position of an image plane are arranged on an optical axis. Nevertheless, the optical system 2 may be a non-coaxial system as necessary. In addition, the optical system 2 according to the present example employs a configuration including only one optical element 1. The configuration, however, is not limited to this. The optical system 2 may employ a configuration including a plurality of optical elements 1. In this case, an optical element satisfying at least Conditional Expressions (1) and (2) may be employed in place of the optical element 1.

### Example 3

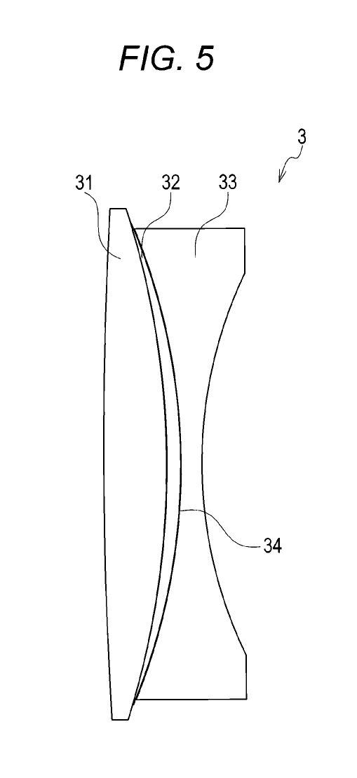

FIG. 5 is a main part sectional view of an optical element 3 according to Example 3 of the present invention. Similarly to the optical element 1 according to Example 1, the optical element 3 according to the present example includes three cemented optical components, but the materials and shapes of optical components and a cement member are different from those of the optical element 1.

In the present example, a first optical component has positive refractive power and a third optical component 33 has negative refractive power. A second optical component 32 is formed of UV curable resin, and is a meniscus-shaped optical component having positive refractive power. The thickness in the optical axis direction of the second optical component 32 decreases from the optical axis toward the end portions. In addition, a cement member 34 is formed of the EP-160 of CEMEDINE CO., LTD., which is epoxy resin-based adhesive. In the present example, the second optical component 32 and the third optical component 33 are cemented to each other via the cement member 34.

The respective Young's moduli E1, E2, and E3 of the first to third optical components are 84.9 GPa, 4.3 GPa, and 102.4 GPa, and the Young's modulus Ec of the cement member 34 is 0.414 GPa, which satisfy the above-described Conditional Expressions (1) and (2). As a result, the shape change of the optical surface of the optical element 3 that is caused by a temperature change can be suppressed.

### Example 4

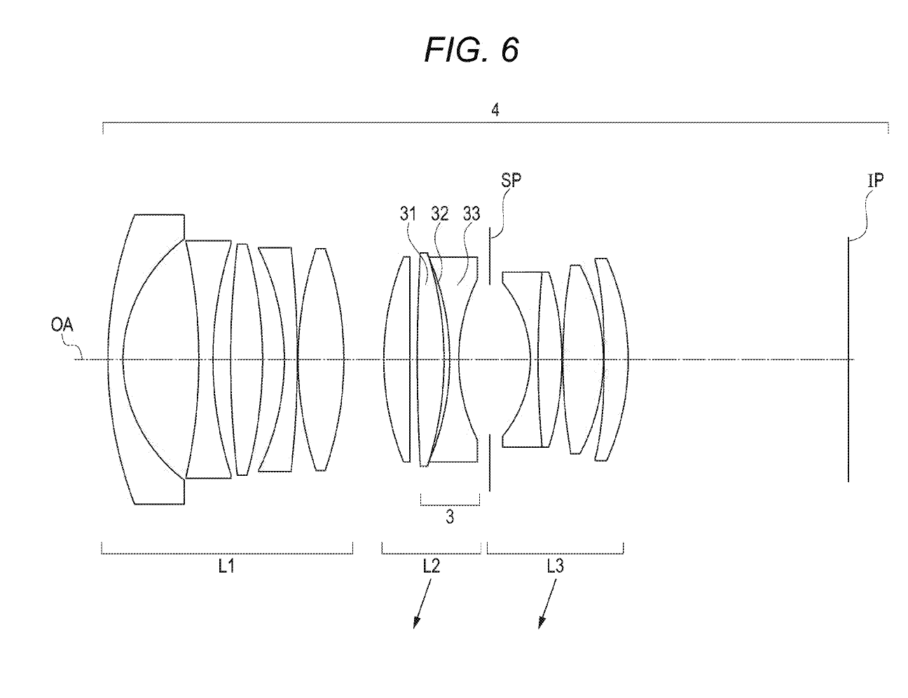

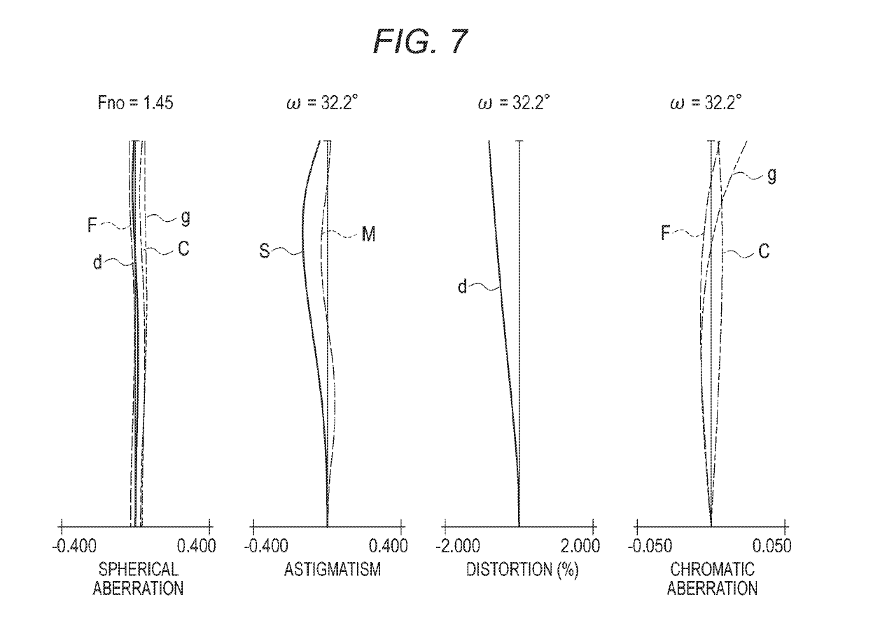

FIG. 6 is a main part sectional view of an optical system 4 according to Example 4 that includes the optical element 3 according to Example 3. FIG. 7 is an aberration diagram of the optical system 4 when the optical system 4 focuses on an infinite object. In the optical system 4 according to the present example, the description of a configuration similar to that of the optical system 2 according to Example 2 will be omitted.

The optical system 4 according to the present example consists of a first lens unit L1 having positive refractive power, a second lens unit L2 having positive refractive power, and a third lens unit L3 having positive refractive power that are arranged in order from an object side to an image side. The second lens unit L2 includes the optical element 3 according to Example 3. In the optical system 4, an interval between lens units changes during focusing.

In the optical element 3, the second optical component 32 formed of UV curable resin has anomalous partial dispersion, and a partial dispersion ratio egF related to a g-line and an F-line thereof is larger as compared with that of general glass material. By employing the optical element 3 having such anomalous partial dispersion, the optical system 4 can effectively correct axial chromatic aberration and transverse chromatic aberration.

### Example 5

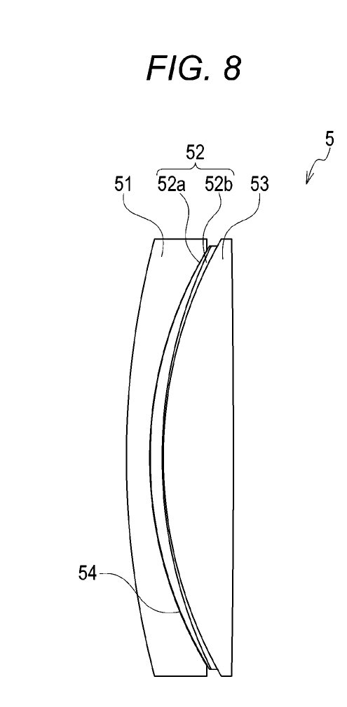

FIG. 8 is a main part sectional view of an optical element 5 according to Example 5 of the present invention. Unlike the optical elements 1 and 3 according to Examples 1 and 3, the optical element 5 according to the present example employs a configuration in which a second optical component 52 formed of organic material is composed of two optical members.

In the present example, a first optical component 51 is an optical component having a negative meniscus shape, and a third optical component 53 is a biconvex-shaped optical component having positive refractive power. The second optical component 52 is composed of two optical members: a first optical member 52a formed of UV curable resin; and a second optical member 52b formed of a compound obtained by dispersing ITO particles in PMMA with a volume ratio of 10%.

In addition, the first optical member 52a is an optical member having a positive meniscus shape with a convex surface facing toward an object side. The thickness in the optical axis direction of the first optical member 52a decreases from the optical axis toward the end portions. The second optical member 52b is an optical member having a negative meniscus shape with a convex surface facing toward an object side. The thickness in the optical axis direction of the second optical member 52b increases from the optical axis toward the end portions.

In addition, a cement member 54 is formed of the LCR0628A of Toagosei Co., Ltd., which is light curing adhesive. In the present example, the first optical component 51 and the first optical member 52a are cemented to each other via the cement member 54. Specifically, the optical element 5 can be manufactured by a step of sequentially forming the second optical member 52b and the first optical member 52a on the third optical component 53, and a step of cementing the first optical member 52a and the first optical component 51 via the cement member 54.

The respective Young's moduli E1, E2a, E2b, and E3 of the first to third optical components are 96 GPa, 4.3 GPa, 1.8 GPa, and 88 GPa, and the Young's modulus Ec of the cement member 54 is 0.01 GPa. Since the optical element 5 according to the present example also satisfies the above-described Conditional Expressions (1) and (2), the shape change of an optical surface that is caused by a temperature change can be suppressed.

In addition, the present example employs a configuration in which the second optical component 52 is composed of two optical members. Alternatively, a configuration in which the second optical component 52 is composed of three or more optical members may be employed as necessary. In addition, as necessary, a diffractive grating may be formed on a boundary surface of optical members constituting the second optical component 52.

### Example 6

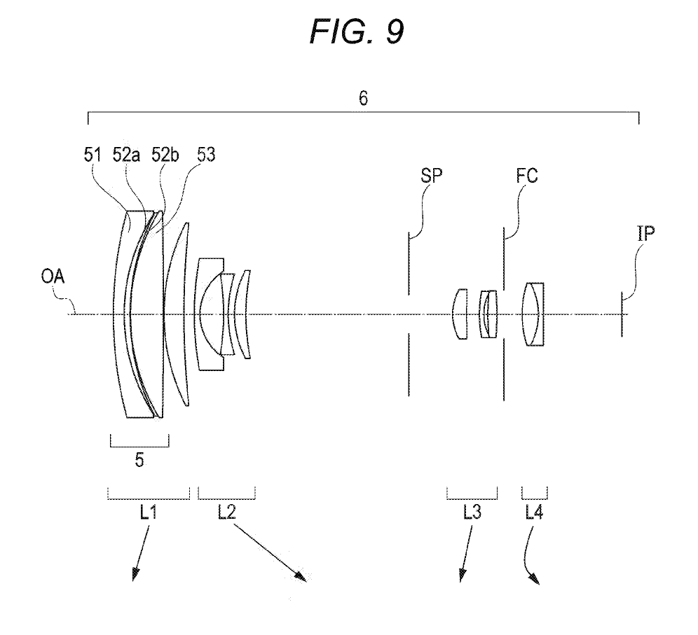

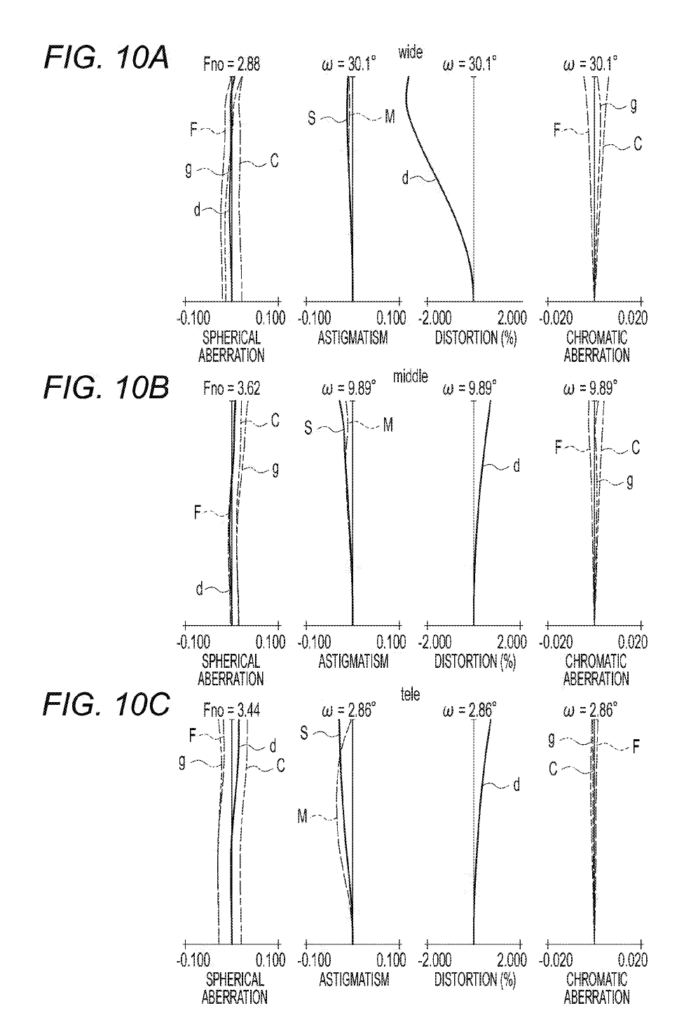

FIG. 9 is a main part sectional view of an optical system 6 according to Example 6 that includes the optical element 5 according to Example 5. In FIG. 9, FC represents a flare cut diaphragm, and arrows represent the loci of movement in the optical axis direction of lens units during zooming from a wide angle end to a telephoto end. FIGS. 10A, 10B, and 10C are respective aberration diagrams of the optical system 6 at a wide angle end, an intermediate zooming position, and a telephoto end. In the optical system 6 according to the present example, the description of a configuration similar to those of the optical systems 2 and 4 according to Examples 2 and 4 will be omitted.

The optical system 6 according to the present example consists of a first lens unit L1 having positive refractive power, a second lens unit L2 having negative refractive power, a third lens unit L3 having positive refractive power, and a fourth lens unit L4 having positive refractive power that are arranged in order from an object side to an image side. The first lens unit L1 includes the optical element 5 according to Example 5. In the optical system 6, an interval between lens units changes during zooming, and a position in the optical axis direction of the fourth lens unit L4 changes during focusing.

In the optical element 5, the second optical component 52 has anomalous partial dispersion. A partial dispersion ratio θgF related to a g-line and an F-line of the first optical member 52a formed of UV curable resin is larger as compared with that of general glass material. In addition, a partial dispersion ratio θgF related to a g-line and an F-line of the second optical member 52b formed of a compound of PMMA and ITO particles is smaller as compared with that of general glass material. By employing the optical element 5 having such anomalous partial dispersion, the optical system 6 can effectively correct axial chromatic aberration and transverse chromatic aberration.

### Example 7

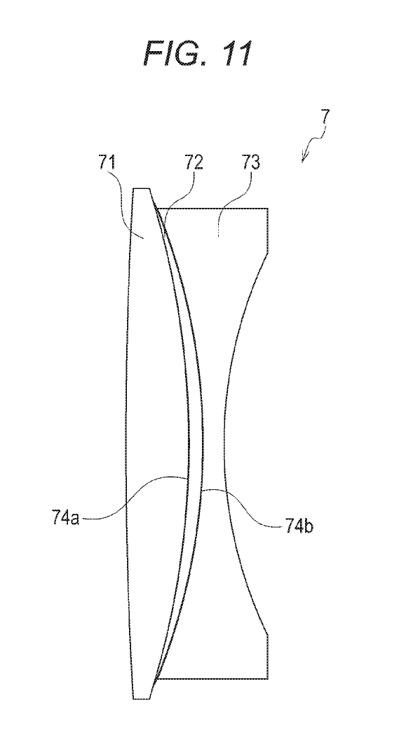

FIG. 11 is a main part sectional view of an optical element 7 according to Example 7 of the present invention. Unlike the optical elements 1, 3, and 5 according to Examples 1, 3, and 5, the optical element 7 according to the present example employs a configuration in which both of the first and third optical components are cemented to the second optical component via a cement member.

In the present example, a first optical component 71 is a biconvex-shaped optical component having positive refractive power and a third optical component 73 is a biconcave-shaped optical component having negative refractive power. A second optical component 72 is formed of UV curable resin, and is a meniscus-shaped optical component having positive refractive power with a concave surface facing toward an object side. The thickness in the optical axis direction of the second optical component 72 decreases from the optical axis toward the end portions. In addition, cement members 74a and 74b are formed of Enethiol resin-based adhesive.

In the present example, the first optical component 71 and the third optical component 73 are cemented to the second optical component 72 via the respective cement members 74a and 74b. The optical element can be manufactured by a step of applying the cement member 74a onto the first optical component 71, a step of forming the second optical component 72 on the cement member 74a, and a step of cementing the second optical component 72 and the third optical component 73 to each other via the cement member 74b.

The respective Young's moduli E1, E2, and E3 of the first to third optical components are 84.9 GPa, 4.3 GPa, and 102.4 GPa, and the Young's moduli Ec of the cement members 74a and 74b are 0.414 GPa, which satisfy the above-described Conditional Expressions (1) and (2). As a result, the shape change of the optical surface of the optical element 7 that is caused by a temperature change can be suppressed.

In the present example, both of the first and third optical components are cemented to the second optical component 72 via the respective cement members 74a and 74b. Thus, the effect of reducing the shape change of the optical surface can be further enhanced. Furthermore, in the present example, the cement member 74b is configured to have slight refractive power so that centers of curvature of the surfaces on the object side and the image side thereof match each other. With this configuration, the thicknesses in the center of curvature direction of the surfaces on the object side and the image side of the cement member 74b become constant in the radial direction. Thus, it is possible to effectively suppress the deformation of the optical element 7 that is caused by a temperature change.

In addition, in each of the above-described examples, when material obtained by mixing particulates of inorganic oxide (e.g., TiO₂, ITO, etc.) into solid-state material is used as the material of the second optical component, it is necessary to suppress light scattering caused by the particulates of inorganic oxide. To this end, it is preferable to set the particle diameter of the particulates within the range from 2 nm to 50 nm. In addition, dispersing agent or the like may be added for suppressing aggregation arising when particulates of inorganic oxide are mixed into solid-state material.

In this case, in a compound obtained by dispersing particulates in solid-state material (base material), a refractive index n (λ) with respect to a wavelength λ can be obtained from a relational expression that is based on the Maxwell-Garnet theory. Specifically, the refractive index n (λ) can be represented by the following Expression (12) based on a relative permittivity εav of the compound that is defined by the following Expression (11), when a relative permittivity of the solid-state material is denoted by εm, a relative permittivity of the particulates is denoted by εp, and the ratio of the total volume of the particulates with respect to the volume of the solid-state material is denoted by η:

$$[ Math . 1 ]$$

$$\begin{matrix}{ɛ}_{av} = [ 1 + \frac{3 η ( \frac{{ɛ}_{p} - {ɛ}_{m}}{{ɛ}_{p} + 2 {ɛ}_{m}} )}{1 - η ( \frac{{ɛ}_{p} - {ɛ}_{m}}{{ɛ}_{p} + 2 {ɛ}_{m}} )} ] , and \\ [ Math . 2 ] & ( 11 ) \\ n ( λ ) = \sqrt{{ɛ}_{av} ( λ )} & ( 12 )\end{matrix}$$

Table 1 lists various numerical values and the values on the middle sides of Conditional Expressions (1) to (10), for the optical elements according to the above-described examples. In addition, in Table 1, t1 and t3 represent the respective maximum thicknesses in the optical axis direction of the first and third optical components, and α1 and α3 represent the respective coefficients of linear expansion of the first and third optical components.

TABLE 1

| | Examples | Examples | Examples | | Example | Conventional |
|---|---|---|---|---|---|---|
| | 1 and 2 | 3 and 4 | 5 and 6 | | 7 | example |
| t1 | 6.08 | 4.76 | 3.97 | | 4.76 | 6.08 |
| t2 | 1.22 | 1.00 | 0.95 | 0.79 | 0.98 | 1.22 |
| t2e | 1.22 | 0.03 | 0.11 | 0.79 | 0.01 | 1.22 |
| t2c | 0.05 | 1.00 | 0.95 | 0.05 | 0.98 | 0.05 |
| t3 | 5.37 | 8.34 | 5.30 | | 8.34 | 5.37 |
| tc | 0.005 | 0.020 | 0.04 | | 0.020 | 0.005 |
| tcc | 0.005 | 0.020 | 0.04 | | 0.020 | 0.005 |
| tce | 0.005 | 0.020 | 0.04 | | 0.018 | 0.005 |
| E1 | 88.4 | 84.9 | 96.0 | | 84.9 | 88.4 |
| E2 | 1.8 | 4.3 | 4.3 | 1.8 | 4.3 | 1.8 |
| E3 | 111.8 | 102.4 | 62.3 | | 102.4 | 111.8 |
| Ec | 0.003 | 0.414 | 0.010 | | 0.009 | 7.900 |
| α1 | 82 | 62 | 88 | | 62 | 82 |
| α2 | 946 | 720 | 720 | 946 | 720 | 946 |
| α3 | 57 | 80 | 90 | | 80 | 57 |
| αc | 1500 | 650 | 1500 | | 650 | 770 |
| φ2 | −0.0047 | 0.0036 | 0.0037 | −0.0016 | 0.0036 | −0.0047 |
| φc | 0.0000 | 0.0000 | 0.0000 | | 0.0000 | 0.0000 |
| Log(E1 × E3/E2²) | 3.51 | 2.67 | 2.82 | | 2.67 | 3.51 |
| Log(E2/Ec) | 2.7 | 1.0 | 2.6 | 2.3 | 2.7 | −0.7 |
| t2e/t2c | 24.360 | 0.025 | 0.116 | 15.800 | 0.005 | 24.360 |
| Log(E2/Ec)/Log | 1.146 | 0.598 | 1.921 | 1.738 | 1.577 | −0.274 |
| (t2/tc) | | | | | | |
| Log((tc × Ec)/(t2 × E2)) | −5.122 | −2.716 | −4.018 | −3.547 | −4.355 | −1.732 |
| \|φc/φ2\| | 0.00 | 0.00 | 0.00 | 0.00 | 0.00 | 0.00 |
| Log(α2/αc)/Log | −0.084 | 0.026 | −0.232 | −0.155 | 0.026 | 0.037 |
| (t2/tc) | | | | | | |
| tcc/t2c | 0.100 | 0.020 | 0.042 | 0.800 | 0.020 | 0.100 |

| | | | | | |
|---|---|---|---|---|---|
| tce/tcc | 1.000 | 1.000 | 1.00 | 0.918 | 1.000 |

Table 2 lists physical properties of the second optical component according to each example.

TABLE 2

| | UV | | | | |
|---|---|---|---|---|---|
| | curable | | | ITO 10% PMMA | ITO 15% PMMA |
| | resin | PMMA | ITO | compound | compound |
| Nd | 1.6356 | 1.4917 | 1.8571 | 1.5265 | 1.5440 |
| Ng | 1.6753 | 1.5025 | 1.9924 | 1.5482 | 1.5713 |
| NC | 1.6281 | 1.4892 | 1.7979 | 1.5188 | 1.5338 |
| NF | 1.6560 | 1.4977 | 1.9487 | 1.5401 | 1.5614 |
| νd | 22.78 | 57.44 | 5.69 | 24.78 | 19.65 |
| θgd | 1.423 | 1.257 | 0.898 | 1.020 | 0.984 |
| θgF | 0.692 | 0.554 | 0.290 | 0.382 | 0.355 |

Table 3 lists physical properties of the cement member according to each example.

TABLE 3

| | E [GPa] | α [1E−7/° C.] |
|---|---|---|
| UV curable resin | 4.300 | 720 |
| PMMA compound | 1.750 | 946 |
| Cemedine EP-160 | 0.414 | 650 |
| Cemedine EP-001K | 0.003 | 1500 |
| LCR0628A | 0.010 | 1500 |
| LCR0632 | 0.290 | 1100 |
| Enethiol resin-based adhesive | 0.009 | 650 |
| TB3114 | 7.900 | 770 |

Next, specific numerical value data in Numerical Examples 1 to 7 respectively corresponding to the above-described Examples 1 to 7 will be given. In each numerical example, m represents the number of a surface counted from a light incident side, rm represents a curvature radius of the mth optical surface (the mth surface), and dm represents an on-axis interval (distance on the optical axis) between the mth surface and the (m+1)th surface. In addition, ndm and νdm respectively represent a refractive index and an Abbe number with respect to a d-line of the mth optical member. Here, the refractive indices with respect to an F-line (486.1 nm), a d-line (587.6 nm), and a C-line (656.3 nm) of Fraunhofer lines are respectively denoted by NF, Nd, and NC, and an Abbe number νd with respect to a d-line is defined by the following Expression (13):

νd=(Nd−1)/(NF−NC) (13).

In addition, in each numerical example, an optical surface with an aspherical surface shape is assigned the sign *(asterisk) after the surface number. In addition, “e±XX” in each aspheric surface coefficient means “×10^{±XX}”. When the amount of displacement from a surface vertex in the optical axis direction is denoted by X, the height from the optical axis in a direction perpendicular to the optical axis direction is denoted by h, a paraxial curvature radius is denoted by r, a conic constant is denoted by k, and aspheric surface coefficients are denoted by B, C, D, E . . . , an aspherical surface shape of the optical surface is represented by the following Expression (14):

$$[ Math . 3 ]$$

$$x = \frac{{h}^{2} \text{/} r}{1 + \sqrt{1 - ( 1 + k ) {( h \text{/} r )}^{2}}} + {Bh}^{4} + {Ch}^{6} + {Dh}^{8} + {Eh}^{10} + … \qquad ( 14 )$$

### Numerical Example 1

| | | | | | Object side | Image side |
|---|---|---|---|---|---|---|
| Surface | | | | | effective | effective |
| number | r | d | nd | vd | diameter | diameter |
| 1 | −20.859 | 1.40 | 1.71736 | 29.5 | — | 26.90 |
| 2 | −526.799 | 0.05 | 1.54402 | 19.7 | 31.50 | 33.00 |
| 3 | 150.060 | 5.37 | 1.69680 | 55.5 | 33.00 | 35.00 |
| 4 | −49.018 | | | | 35.00 | |

### Numerical Example 2

| Surface | | | | | Effective |
|---|---|---|---|---|---|
| number | r | d | nd | vd | diameter |
| 1 | 55.052 | 1.39 | 1.58313 | 59.4 | 50.00 |
| 2* | 25.148 | 13.72 | | | 42.43 |
| 3 | −106.406 | 2.03 | 1.51633 | 64.1 | 42.14 |
| 4 | 50.816 | 3.68 | | | 40.61 |
| 5 | 113.354 | 6.23 | 1.91082 | 35.3 | 40.83 |
| 6 | −89.012 | 7.06 | | | 40.66 |
| 7 | −44.957 | 2.03 | 1.69895 | 30.1 | 37.20 |
| 8 | −336.413 | 0.17 | | | 37.42 |
| 9 | 69.607 | 8.37 | 1.59522 | 67.7 | 37.46 |
| 10 | −50.652 | (Variable) | | | 37.88 |
| 11 | 43.189 | 5.19 | 2.00100 | 29.1 | 35.48 |
| 12 | 1039.705 | 0.14 | | | 34.68 |
| 13 | 78.829 | 5.45 | 1.59522 | 67.7 | 32.76 |
| 14 | −62.807 | 1.54 | 1.85026 | 32.3 | 31.30 |
| 15 | 28.545 | (Variable) | | | 27.08 |
| 16(Diaphragm) | ∞ | 7.24 | | | 26.48 |
| 17 | −20.859 | 1.40 | 1.71736 | 29.5 | 25.82 |
| 18 | −526.799 | 0.05 | 1.54402 | 19.6 | 28.63 |
| 19 | 150.060 | 5.37 | 1.69680 | 55.5 | 29.15 |
| 20 | −49.018 | 0.15 | | | 30.23 |
| 21 | 122.455 | 6.57 | 1.65160 | 58.5 | 31.49 |
| 22 | −37.407 | 0.19 | | | 32.50 |
| 23* | −82.464 | 3.70 | 1.85400 | 40.4 | 33.20 |
| 24 | −40.578 | (Variable) | | | 34.31 |
| Image plane | ∞ | | | | |

Aspherical surface data

The second surface
K = 0.00000e+000 B = −1.17609e−006 C = −3.67097e−009
D = 4.77220e−012 E = −1.15057e−014
The twenty−third surface
K = 0.00000e+000 B = −6.57816e−006 C = −1.77654e−010−
D = −5.21093e−012 E = 4.55629e−015

Various data

| | |
|---|---|
| Focal length | 34.30 |
| F-number | 1.45 |
| Field angle | 32.24 |
| Image height | 21.64 |
| Total lens length | 133.69 |
| BF | 39.00 |

| | | | |
|---|---|---|---|
| Object distance | Infinity | 1750 | 300 |
| d10 | 7.10 | 6.36 | 0.80 |
| d15 | 5.92 | 5.92 | 5.92 |
| d24 | 39.00 | 39.74 | 45.30 |

| | |
|---|---|
| Position of entrance pupil | 36.86 |
| Position of exit pupil | −36.49 |
| Front principal point position | 55.58 |
| Rear principal point position | 4.70 |

Lens unit data

| | | | | Front | Rear |
|---|---|---|---|---|---|
| | | | Lens | principal | principal |
| | Starting | Focal | structure | point | point |
| Unit | surface | length | length | position | position |
| 1 | 1 | 185.01 | 44.67 | 86.61 | 92.68 |
| 2 | 11 | 594.71 | 12.33 | −126.75 | −110.20 |
| 3 | 16 | 44.66 | 24.67 | 22.33 | 8.15 |

Single lens element

| | Starting | Focal |
|---|---|---|
| Lens | surface | length |
| 1 | 1 | −80.78 |
| 2 | 3 | −66.32 |
| 3 | 5 | 55.56 |
| 4 | 7 | −74.46 |
| 5 | 9 | 50.57 |
| 6 | 11 | 44.90 |
| 7 | 13 | 59.58 |
| 8 | 14 | −22.90 |
| 9 | 17 | −30.31 |
| 10 | 18 | −214.68 |
| 11 | 19 | 53.62 |
| 12 | 21 | 44.70 |
| 13 | 23 | 89.89 |

### Numerical Example 3

| | | | | | Object side | Image side |
|---|---|---|---|---|---|---|
| Surface | | | | | effective | effective |
| number | r | d | nd | vd | diameter | diameter |
| 1 | 333.607 | 4.76 | 1.60311 | 60.6 | — | 38.00 |
| 2 | −61.478 | 1.00 | 1.63556 | 22.4 | 38.00 | 35.80 |
| 3 | −45.844 | 1.59 | 1.72825 | 28.5 | 35.80 | 35.00 |
| 4 | 32.360 | | | | 28.40 | — |

### Numerical Example 4

| Surface | | | | | Effective |
|---|---|---|---|---|---|
| number | r | d | nd | vd | diameter |
| 1 | 72.080 | 2.65 | 1.58313 | 59.4 | 50.00 |
| 2* | 25.512 | 13.45 | | | 41.33 |
| 3 | −96.609 | 2.50 | 1.48749 | 70.2 | 40.75 |
| 4 | 66.944 | 3.13 | | | 39.59 |
| 5 | 175.419 | 5.63 | 1.91082 | 35.3 | 39.68 |
| 6 | −77.862 | 3.86 | | | 39.54 |
| 7 | −44.606 | 2.30 | 1.69895 | 30.1 | 38.10 |
| 8 | −178.782 | 0.15 | | | 38.34 |
| 9 | 62.257 | 8.11 | 1.59522 | 67.7 | 38.01 |
| 10 | −59.637 | (Variable) | | | 37.40 |
| 11 | 48.797 | 4.61 | 2.00100 | 29.1 | 35.03 |
| 12 | 9939.838 | 1.32 | | | 34.39 |
| 13 | 333.607 | 4.76 | 1.60311 | 60.6 | 32.67 |
| 14 | −61.478 | 1.00 | 1.63556 | 22.4 | 31.18 |
| 15 | −45.844 | 1.59 | 1.72825 | 28.5 | 30.99 |
| 16 | 32.360 | (Variable) | | | 27.20 |
| 17(Diaphragm) | ∞ | 7.17 | | | 26.60 |
| 18 | −21.286 | 1.40 | 1.69895 | 30.1 | 25.93 |
| 19 | 177.619 | 4.21 | 1.59522 | 67.7 | 28.93 |
| 20 | −52.749 | 0.15 | | | 29.70 |
| 21 | 97.355 | 7.19 | 1.59522 | 67.7 | 31.37 |
| 22 | −35.549 | 0.15 | | | 32.12 |
| 23* | −158.409 | 4.26 | 1.85400 | 40.4 | 33.44 |
| 24 | −43.693 | (Variable) | | | 34.50 |
| Image plane | ∞ | | | | |

Aspherical surface data

The second surface
K = 0.00000e+000 B = −1.26283e−006 C = −4.27073e−009
D = 5.04254e−012 E = −1.12945e−014
The twenty−third surface
K = 0.00000e+000 B = −6.35905e−006 C = −4.47403e−010
D = −4.21764e−012 E = 2.36025e−015

Various data

| | |
|---|---|
| Focal length | 34.30 |
| F-number | 1.45 |
| Field angle | 32.24 |
| Image height | 21.64 |
| Total lens length | 131.15 |
| BF | 39.00 |

| | | | |
|---|---|---|---|
| Object distance | Infinity | 1750 | 300 |
| d10 | 7.06 | 6.32 | 0.80 |
| d18 | 5.50 | 5.50 | 5.50 |
| d26 | 39.00 | 39.74 | 45.26 |

| | |
|---|---|
| Position of entrance pupil | 35.71 |
| Position of exit pupil | −37.10 |
| Front principal point position | 54.55 |
| Rear principal point position | 4.70 |

Lens unit data

| | | | | Front | Rear |
|---|---|---|---|---|---|
| | | | Lens | principal | principal |
| | Starting | Focal | structure | point | point |
| Unit | surface | length | length | position | position |
| 1 | 1 | 170.03 | 41.79 | 78.71 | 82.50 |
| 2 | 11 | 783.13 | 13.28 | −152.17 | −134.21 |
| 3 | 17 | 44.42 | 24.52 | 22.40 | 8.09 |

Single lens element

| | Starting | Focal |
|---|---|---|
| Lens | surface | length |
| 1 | 1 | −69.17 |
| 2 | 3 | −80.71 |
| 3 | 5 | 59.84 |
| 4 | 7 | −85.64 |
| 5 | 9 | 52.48 |
| 6 | 11 | 48.98 |
| 7 | 13 | 86.47 |
| 8 | 14 | 276.77 |
| 9 | 15 | −25.83 |
| 10 | 18 | −27.12 |
| 11 | 19 | 68.80 |
| 12 | 21 | 44.65 |
| 13 | 23 | 69.46 |

### Numerical Example 5

| | | | | | Object side | Image side |
|---|---|---|---|---|---|---|
| Surface | | | | | effective | effective |
| number | r | d | nd | vd | diameter | diameter |
| 1 | 64.220 | 1.75 | 1.84666 | 23.8 | — | 32.50 |
| 2 | 29.865 | 0.94 | 1.63556 | 22.8 | 34.50 | 31.50 |
| 3 | 35.779 | 0.05 | 1.52651 | 24.8 | 31.50 | 31.50 |
| 4 | 32.261 | 5.30 | 1.48749 | 70.2 | 31.50 | 33.00 |
| 5 | −1189.473 | 0.10 | | | 33.00 | — |

### Numerical Example 6

| Surface | | | | | Effective |
|---|---|---|---|---|---|
| number | r | d | nd | vd | diameter |
| 1 | 64.220 | 1.75 | 1.84666 | 23.8 | 32.00 |
| 2 | 29.865 | 0.94 | 1.63556 | 22.8 | 29.84 |
| 3 | 35.779 | 0.05 | 1.52651 | 24.8 | 29.78 |
| 4 | 32.261 | 5.30 | 1.48749 | 70.2 | 29.66 |
| 5 | −1189.473 | 0.10 | | | 29.22 |
| 6 | 32.482 | 3.23 | 1.77250 | 49.6 | 28.20 |
| 7 | 140.080 | (Variable) | | | 27.86 |
| 8 | 51.133 | 0.90 | 1.88300 | 40.8 | 16.81 |
| 9 | 8.275 | 3.81 | | | 12.93 |
| 10 | −38.963 | 0.75 | 1.60738 | 56.8 | 12.89 |
| 11 | 21.403 | 1.00 | | | 12.75 |
| 12 | 15.132 | 1.84 | 1.92286 | 18.9 | 13.20 |
| 13 | 36.354 | (Variable) | | | 12.92 |
| 14(Diaphragm) | ∞ | (Variable) | | | 6.29 |
| 15* | 7.801 | 2.27 | 1.55880 | 62.5 | 7.38 |
| 16 | 268.502 | 2.06 | | | 7.12 |
| 17 | 20.932 | 0.70 | 1.80610 | 33.3 | 6.94 |
| 18 | 7.517 | 0.62 | | | 6.71 |
| 19 | 34.492 | 1.46 | 1.56873 | 63.1 | 6.71 |
| 20 | −61.306 | (Variable) | | | 6.99 |
| 21 | ∞ | (Variable) | | | 7.85 |
| 22 | 16.816 | 2.59 | 1.72916 | 54.7 | 9.33 |
| 23 | −10.631 | 0.80 | 1.73800 | 32.3 | 9.16 |
| 24 | 1995.188 | (Variable) | | | 9.00 |
| Image plane | ∞ | | | | |

Aspherical surface data

The fifteenth surface
K = −4.19230e−001 B = −5.01477e−005 C = −1.48975e−006
D = 1.05713e−007 E = −3.27034e−009

Various data
Zoom ratio 11.59

| | Wide angle | Intermediate | Telephoto |
|---|---|---|---|
| Focal length | 6.15 | 20.45 | 71.28 |
| F-number | 2.88 | 3.62 | 3.44 |
| Field angle | 30.09 | 9.89 | 2.86 |
| Image height | 3.56 | 3.56 | 3.56 |
| Total lens length | 81.87 | 85.95 | 87.02 |
| BF | 12.65 | 16.24 | 11.72 |
| d7 | 1.68 | 18.58 | 31.68 |
| d13 | 26.21 | 12.62 | 1.42 |
| d14 | 7.07 | 2.00 | 2.00 |
| d20 | 1.10 | 2.77 | 4.09 |
| d21 | 2.99 | 3.56 | 5.93 |
| d24 | 12.65 | 16.24 | 11.72 |
| Position of entrance pupil | 22.71 | 77.55 | 230.34 |
| Position of exit pupil | −52.67 | −30.52 | −57.78 |
| Front principal point position | 28.28 | 89.03 | 226.78 |
| Rear principal point position | 6.49 | −4.34 | −61.17 |

Lens unit data

| | | | | Front | Rear |
|---|---|---|---|---|---|
| | | | Lens | principal | principal |
| | Starting | Focal | structure | point | point |
| Unit | surface | length | length | position | position |
| 1 | 1 | 48.76 | 11.38 | 3.72 | −3.43 |
| 2 | 8 | −10.49 | 8.29 | 0.64 | −6.09 |
| 3 | 15 | 25.04 | 7.12 | −3.78 | −8.31 |
| 4 | 22 | 23.67 | 3.39 | −0.05 | −2.00 |

Single lens element

| | Starting | Focal |
|---|---|---|
| Lens | surface | length |
| 1 | 1 | −67.51 |
| 3 | 2 | 267.77 |
| 4 | 3 | −626.34 |
| 5 | 4 | 64.52 |
| 6 | 6 | 54.03 |
| 7 | 8 | −11.29 |
| 8 | 10 | −22.64 |
| 9 | 12 | 26.97 |
| 10 | 15 | 14.33 |
| 11 | 17 | −14.90 |
| 12 | 19 | 39.03 |
| 13 | 22 | 9.30 |
| 14 | 23 | −14.33 |

### Numerical Example 7

| | | | | | Object side | Image side |
|---|---|---|---|---|---|---|
| Surface | | | | | effective | effective |
| number | r | d | nd | vd | diameter | diameter |
| 1 | 333.607 | 4.76 | 1.60311 | 60.6 | — | 38.00 |
| 2 | −61.478 | 0.01 | 1.55540 | 45.2 | 35.80 | 35.80 |
| 3 | −61.478 | 1.00 | 1.63556 | 22.4 | 35.80 | 35.80 |
| 4 | −45.834 | 0.01 | 1.55540 | 45.2 | 35.80 | 35.00 |
| 5 | −45.844 | 1.59 | 1.72825 | 28.5 | 35.80 | 35.00 |
| 6 | 32.360 | | | | 28.40 | — |

### [Optical Apparatus]

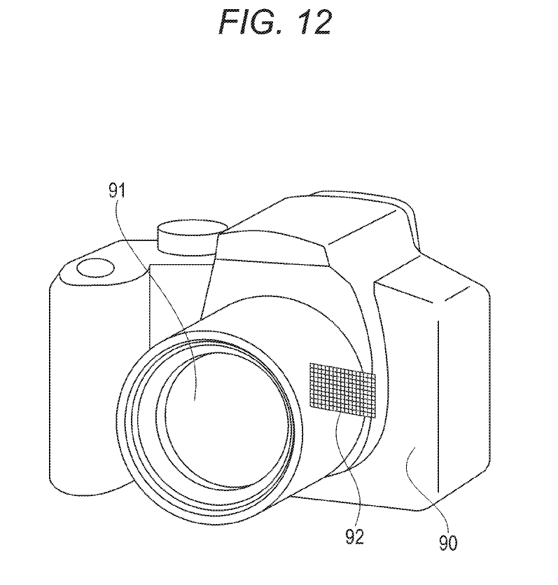

FIG. 12 is a main part schematic view of an imaging apparatus (a digital still camera) serving as an optical apparatus according to an exemplary embodiment of the present invention. The imaging apparatus according to the present exemplary embodiment includes a camera main body 90, an imaging optical system 91 including the optical element according to any of the above-described examples, and a light receiving element (an image sensor) 92 that receives light from the imaging optical system 91, and photoelectrically converts a subject image formed by the imaging optical system 91.

According to the imaging apparatus according to the present exemplary embodiment, by employing the optical element according to any of the above-described examples, high optical performance can be achieved, so that a high-quality image can be obtained. In addition, a solid-state image sensor (an electric image sensor) such as a charge-coupled device (CCD) sensor and a complementary metal-oxide semiconductor (CMOS) sensor can be used as the light receiving element 92. In this case, by electrically correcting various aberrations such as distortion aberration and chromatic aberration of an image obtained by the light receiving element 92, the image quality of an output image can be improved.

In addition, the application of the optical elements according to the above-described examples is not limited to the digital still camera illustrated in FIG. 12, and the optical elements are applicable to various optical apparatuses such as a silver-halide film camera, a video camera, a telescope, binoculars, a projector, and a digital copying machine.

As described above, preferred exemplary embodiments and examples of the present invention have been described. The present invention, however, is not limited to these exemplary embodiments and examples, and various combinations, modifications, and changes can be made without departing from the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-074504, filed Mar. 31, 2015, which is hereby incorporated by reference herein in its entirety.

What is claimed is:

1. An optical element comprising a first optical component, a second optical component cemented to the first optical component, and a third optical component cemented to the second optical component,
wherein at least either one of the first and third optical components and the second optical component are cemented to each other via a cement member, and wherein following conditional expressions are satisfied:
−0.5<Log(E1×E3/E2²)<10,
and
−0.2<Log(E2/Ec)<10,
where Young's moduli of the first to third optical components and the cement member are respectively denoted by E1, E2, E3, and Ec.

2. The optical element according to claim 1, wherein a following conditional expression is satisfied:
0<t2e/t2c<0.95,
where thicknesses in an optical axis direction on an optical axis and at a maximum diameter of the second optical component are respectively denoted by t2c and t2e.

3. The optical element according to claim 1, wherein a following conditional expression is satisfied:
1.05<t2e/t2c<10000,
where thicknesses in an optical axis direction on an optical axis and at a maximum diameter of the second optical component are respectively denoted by t2c and t2e.

4. The optical element according to claim 1, wherein a following conditional expression is satisfied:
0<Log(E2/Ec)/Log(t2/tc)<20,
where maximum thicknesses in an optical axis direction of the second optical component and the cement member are respectively denoted by t2 and tc.

5. The optical element according to claim 1, wherein a following conditional expression is satisfied:
−20<Log(tc×Ec/(t2×E2))<0,
where maximum thicknesses in an optical axis direction of the second optical component and the cement member are respectively denoted by t2 and tc.

6. The optical element according to claim 1, wherein a following conditional expression is satisfied:
0≦|φc/φ2|<0.2,
where refractive powers of the second optical component and the cement member are respectively denoted by φ2 and φc.

7. The optical element according to claim 1, wherein a following conditional expression is satisfied:
−10<Log(α2/αc)/Log(t2/tc)<10,
where coefficients of linear expansion of the second optical component and the cement member are respectively denoted by α2 and αc.

8. The optical element according to claim 1, wherein a following conditional expression is satisfied:
0≦tcc/t2c<1,
where thicknesses in an optical axis direction on an optical axis of the second optical component and the cement member are respectively denoted by t2c and tcc.

9. The optical element according to claim 1, wherein a following conditional expression is satisfied:
0.8<tce/tcc<1.2,
where a thickness in an optical axis direction on an optical axis of the cement member is denoted by tcc and a thickness in the optical axis direction at a maximum diameter of the cement member is denoted by tce.

10. The optical element according to claim 1, wherein the second optical component is formed of organic material.

11. The optical element according to claim 10, wherein the second optical component is formed of resin material.

12. The optical element according to claim 10, wherein the second optical component is formed of a compound obtained by dispersing inorganic particulates in resin material.

13. The optical element according to claim 1, wherein the second optical component is formed by cementing a plurality of optical members being formed of materials different from one another.

14. The optical element according to claim 13, wherein the second optical component is formed by cementing a first optical member formed of resin material and a second optical member formed of a compound obtained by dispersing inorganic particulates in resin material.

15. The optical element according to claim 1, wherein the first and third optical components are formed of inorganic glass.

16. An optical system comprising:
an optical element; and
an aperture diaphragm arranged on an object side or an image side of the optical element,
wherein the optical element includes a first optical component, a second optical component cemented to the first optical component, and a third optical component cemented to the second optical component,
wherein at least either one of the first and third optical components and the second optical component are cemented to each other via a cement member, and wherein following conditional expressions are satisfied:
−0.5<Log(E1×E3/E2²)<10,
and
−0.2<Log(E2/Ec)<10,
where Young's moduli of the first to third optical components and the cement member are respectively denoted by E1, E2, E3, and Ec.

17. A manufacturing method of an optical element, the manufacturing method comprising:
a step of forming a first optical component by first material;
a step of forming a second optical component by second material;
a step of forming a third optical component by third material; and
a step of cementing the first to third optical components to one another,
wherein, in the step of cementing, at least either one of the first and third optical components and the second optical component are cemented to each other via a cement member, and
wherein following conditional expressions are satisfied:
−0.5<Log(E1×E3/E2²)<10,
and
−0.2<Log(E2/Ec)<10,
where Young's moduli of the first to third materials and the cement member are respectively denoted by E1, E2, E3, and Ec.
